(19) United States
(12) Patent Application Publication
(10) Pub. No.: US 2008/0007532 A1
(43) Pub. Date: Jan. 10, 2008

(54) Touch-sensitive pad capable of detecting depressing pressure

(75) Inventor: Steven Chen, Changhua (TW)

Correspondence Address: BRUCE H. TROXELL, SUITE 1404, 5205 LEESBURG PIKE, FALLS CHURCH, VA, 22041, US

(73) Assignee: E-LEAD ELECTRONIC CO., LTD.

(21) Appl. No.: 11/480,399

(22) Filed: Jul. 5, 2006

(51) Int. Cl. G06F 3/041

(52) U.S. Cl. 345/173

(57) ABSTRACT

A touch-sensitive pad capable of detecting depressing pressure aims to detect different depressing pressure of a user's finger to confirm a depressing action. It includes at least a touch-sensitive pad, a piezoelectric ceramic pad and a voltage detection circuit. The touch-sensitive pad can detect and get a signal resulting from touching and moving of the finger. The piezoelectric ceramic pad generates voltage alterations upon receiving different depressing pressure of the finger that are determined by a microprocessor of the voltage detection circuit to confirm the depressing action of an operator, thereby moving of the cursor and input of an icon key can be controlled.

### BACKGROUND OF THE INVENTION

1. Field of the Invention

The invention relates to a touch-sensitive pad capable of detecting depressing pressure and particularly to a touch-sensitive pad capable of detecting different depressing pressure of a finger to confirm a depressing action to control movement of a cursor and input of an icon key.

2. Description of the Prior Art

Touch-sensitive pad is used on notebook computers to control the cursor on the screen. As it can detect touch and movement of the finger, it is used as a cursor controller to drive the movement of the cursor on the screen. It is small size and occupies a small area, thus has become a fundamental accessory of the notebook computer. The touch-sensitive pad generally can be divided into capacitance type and resistance type. Its operation principle is based on alterations of capacitance or resistance generated by touching of a finger and a coordinate process to get the center location of the touching area of the finger and the displacement thereof, and conversion of the displacement to a cursor displacement on the screen to control movement of the cursor.

Although the touch-sensitive pad can move the cursor quickly, when the cursor is moved to a selected icon on the screen to do selection or execution of the icon, a button key outside the touch-sensitive pad is still needed. As the fingers have to control the cursor and also have to take care of the button key to complete depression of the button key, operation is not convenient. Moreover, the driving program of some touch-sensitive pads allows users to tap the touch-sensitive pad rapidly and consecutively to substitute extra button keys. While such an approach can improve operation convenience, it is still not as convenient as moving the cursor to the selected item and depressing the key. In addition, in some operation systems such as Windows, the cursor controller has a left key and a right key that function differently. To do tapping rapidly and consecutively can replace only the left key function but not the right key function. Hence it still has disadvantages in use.

### SUMMARY OF THE INVENTION

In view of the aforesaid problems, it is an object of the present invention to provide a touch-sensitive pad capable of detecting depressing pressure. It includes at least a touch-sensitive pad, a piezoelectric ceramic pad and a voltage detection circuit. The touch-sensitive pad can detect touching and moving signals of a finger. The piezoelectric ceramic pad receives different depressing pressure of the finger and generates voltage alterations. The voltage detection circuit has a microprocessor to do determination to confirm the depressing action of a user. Thereby it can be used to control movement of the cursor and input of an icon key.

In one aspect, the touch-sensitive pad of the invention can function as a left key and a right key according the depressing pressure, such as tapping lightly represents the left key while striking heavily represents the right key.

In another aspect, the voltage detection circuit of the invention further includes a voltage oscillation circuit to drive vibration of the piezoelectric ceramic pad in response to user's depression.

In yet another aspect, the touch-sensitive pad and the piezoelectric ceramic pad are bonded together by soldering.

In still another aspect, the voltage detection circuit confirms user's depressing action according to the value of positive voltage generated by the piezoelectric ceramic pad.

In yet another aspect, the voltage detection circuit detects leaving of the finger to confirm finishing of the depressing action.

In yet another aspect, the voltage detection circuit detects an inverse voltage of the piezoelectric ceramic pad to confirm finishing of the depressing action.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is another exploded view of the invention.

FIG. 3 is a block diagram of an embodiment of the invention.

FIG. 4 is a schematic view of the invention showing voltage alteration during depression.

FIG. 5 is an operational flow chart of the invention.

### DESCRIPTION OF THE PREFERRED EMBODIMENTS

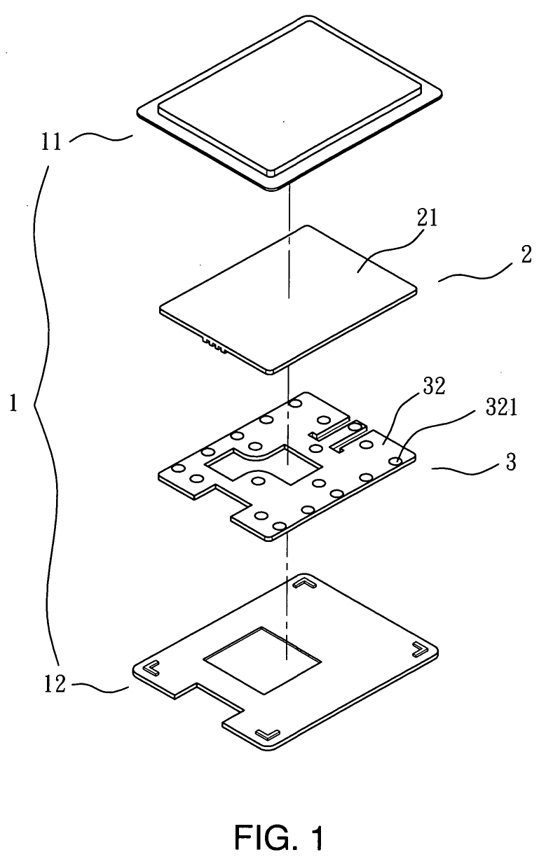

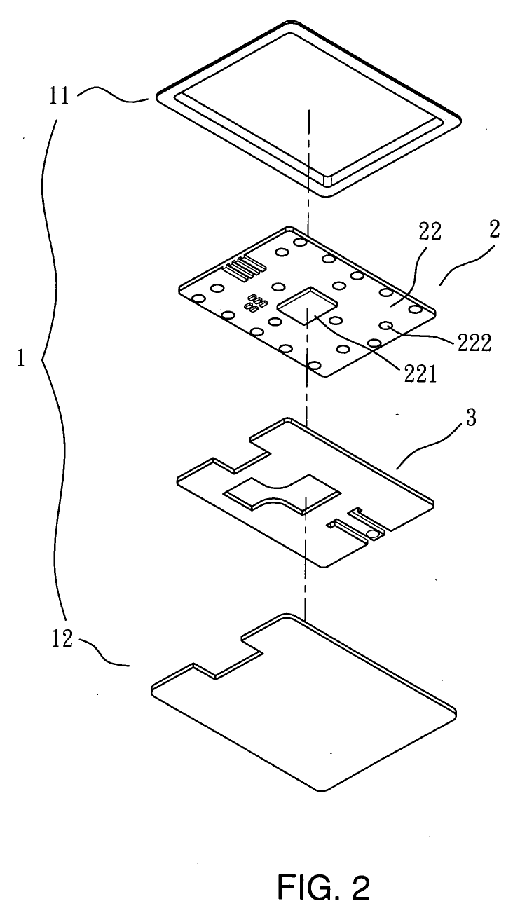

Referring to FIGS. 1 and 2, the touch-sensitive pad capable of detecting depressing pressure of the invention includes at least a touch-sensitive pad 2, a piezoelectric ceramic pad 3 and a voltage detection circuit 4.

The touch-sensitive pad 2 can detect touching of a finger and recognize the location coordinate of the finger. It has arranged electrodes coupling with static charges of a human body to generate capacitance alterations to form an induction current to detect the coordinate position. The touch-sensitive pad 2 has a top surface 21 to form an induction zone, a bottom surface 22 to hold a circuit 221 and at least one first contact 222.

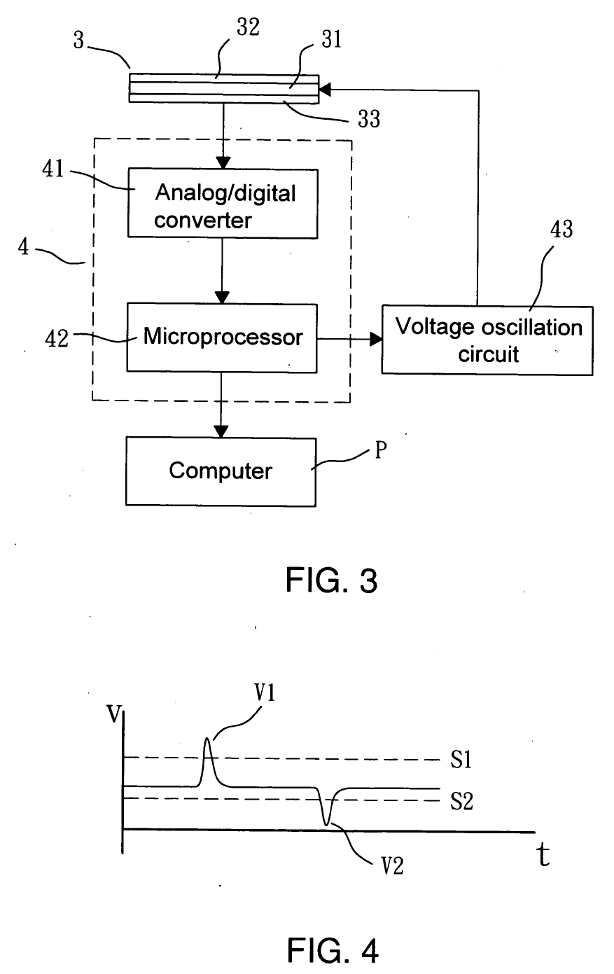

The piezoelectric ceramic pad 3 is bonded to a lower side of the touch-sensitive pad 2, and includes a base layer 31 with a plated conductive layer 32 located thereon and a metal layer 33 located thereunder (also referring to FIG. 3). The plated conductive layer 32 has at least one second contact 321 corresponding and bonding to the first contact 222 by soldering.

The voltage detection circuit 4 aims to detect the voltage generated by the piezoelectric ceramic pad 3 upon receiving a pressure (referring to FIG. 3). It includes an analog/digital converter 41 to transform an analog voltage output from the piezoelectric ceramic pad 3 to a digital signal and a microprocessor 42 to receive the digital signal output from the analog/digital converter 41 to determine alterations of the digital signal.

The touch-sensitive pad mentioned above further may be held in a frame 1 which includes a upper cap 11 and a base 12. The base 12 provides bracing and anchoring. The upper cap 11 is a membrane shell to cover the top surface 21 of the touch-sensitive pad 2 to protect and prevent the touch-sensitive pad from scrapping or being damaged.

The base layer 31 of the piezoelectric ceramic pad 3 is made from ceramics such as BAT103, PZT or the like.

The metal base 33 of the piezoelectric ceramic pad 3 is a conductive metal blade such as a copper blade.

When the piezoelectric ceramic pad 3 receives a pressure from a user's finger, it is deformed slightly and outputs a positive first voltage V1. When the pressure of the finger is released (the pressure disappears), the piezoelectric ceramic pad 3 returns to the original shape and generates an inverse second voltage V2 (referring to FIG. 4).

The voltage detection circuit 4 includes a voltage oscillation circuit 43. When the microprocessor 43 receives the first voltage V1 (or second voltage V2) which has an alteration greater than a first rated value S1 (or a second rated value S2), an AC voltage is sent to the piezoelectric ceramic pad 3 to generate a reciprocal deforming vibration so that user's finger can sense a slight vibration to confirm the depression.

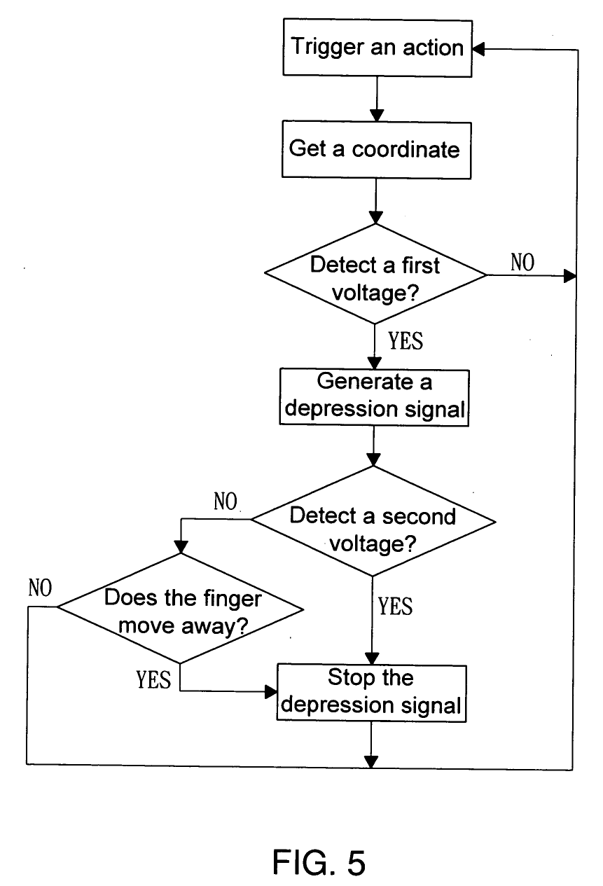

By means of the aforesaid construction, operation via the touch-sensitive pad by a user includes the following steps (referring to FIGS. 3 and 5):

Step 1: Trigger an action: the touch-sensitive pad 2 detects touching of a user's finger through induction;

Step 2: Obtain a coordinate: the touch-sensitive pad 2 gets the coordinate of the position of the finger through the circuit 221 on the bottom surface 22;

Step 3: Detect the first voltage: the voltage detection circuit 4 detects whether alteration occurs to the first voltage V1 output from the piezoelectric ceramic pad 3. If the first voltage V1 is greater than the first rated value S1, execute step 4; otherwise, execute step 1;

Step 4: Generate a depression signal: the voltage detection circuit 4 outputs a depression signal to a computer P to confirm a depressing action of the finger;

Step 5: Detect the second voltage: the voltage detection circuit 4 detects whether alteration occurs to the second voltage V2 output from the piezoelectric ceramic pad 3. If the second voltage V2 is smaller than the second rated value S2, execute step 7; otherwise, execute step 6;

Step 6: Determine whether the finger has moved away: the touch-sensitive pad 3 detects whether the finger has moved away; if positive, execute step 7; otherwise, execute step 1; and

Step 7: Stop the depression signal: the voltage detection circuit 4 outputs a depression stop signal to the computer P to confirm that the depression action of the finger stops.

In summary, the invention can overcome the disadvantages of the conventional touch-sensitive pad. Aside from moving the cursor rapidly on the screen, it provides an intuitive depressing function for a button key to enable users to control input of an icon key.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. A touch-sensitive pad to detect a depressing pressure, comprising at least:
a touch-sensitive pad to detect touching of a user's finger and recognize the coordinate of the position of the finger;
a piezoelectric ceramic pad bonding to a lower side of the touch-sensitive pad; and
a voltage detection circuit to detect a voltage generated by the piezoelectric ceramic pad upon receiving a pressure.

2. The touch-sensitive pad of claim 1, wherein the voltage detection circuit includes an analog/digital converter to transform an analog voltage output from the piezoelectric ceramic pad to a digital signal.

3. The touch-sensitive pad of claim 1 or 2, wherein the voltage detection circuit further includes a microprocessor to receive the digital signal output from the analog/digital converter and determine alteration of the digital signal.

4. The touch-sensitive pad of claim 1, wherein the voltage detection circuit further includes a voltage oscillation circuit to drive the piezoelectric ceramic pad to vibrate to respond and confirm a user's depressing action.

5. The touch-sensitive pad of claim 1, wherein the touch-sensitive pad and the piezoelectric ceramic pad are bonded by soldering.

6. The touch-sensitive pad of claim 1, wherein the voltage detection circuit detects a positive voltage generated by the piezoelectric ceramic pad to confirm a user's depressing action.

7. The touch-sensitive pad of claim 1, wherein the voltage detection circuit detects an inverse voltage generated by the piezoelectric ceramic pad to confirm stopping of a user's depressing action.

8. The touch-sensitive pad of claim 1, wherein the touch-sensitive pad detects moving away of the finger to confirm stopping of a button key operation.
